(19) United States
(12) Patent Application Publication
(10) Pub. No.: US 2023/0263331 A1
(43) Pub. Date: Aug. 24, 2023

(54) REVERSE COFFEE EXTRACTION DEVICE USING A PUMP

(71) Applicant: HOSEO UNIVERSITY ACADEMIC COOPERATION FOUNDATION, Chungcheongnam-do (KR)

(72) Inventors: Seung Min HWANG, Chungcheongnam-do (KR); Byong Min SEO, Daejeon (KR); Su Nam OH, Chungcheongnam-do (KR); Sang Mok KIM, Chungcheongnam-do (KR)

(21) Appl. No.: 18/113,183

(22) Filed: Feb. 23, 2023

(30) Foreign Application Priority Data
Feb. 23, 2022 (KR) 10-2022-023675
Dec. 29, 2022 (KR) 10-2022-0189304

(51) Int. Cl. A47J 31/057; A47J 31/46; A47J 31/60; C02F 1/48; B03C 1/30

(52) U.S. Cl. CPC A47J 31/057; A47J 31/468; A47J 31/461; A47J 31/605; C02F 1/488; B03C 1/30; C02F 2101/203

(57) ABSTRACT

A reverse coffee extraction device according to an embodiment includes a pump configured to pump water upwards; and a brewing container installed above the pump to extract coffee, wherein the water pumped upwards is delivered to the brewing container and moves upwards, and the coffee in the brewing container is brewed and extracted to an outside while the water supplied down moves up.

### CROSS-REFERENCE TO RELATED APPLICATION AND CLAIM OF PRIORITY

This application claims the benefit under 35 USC § 119 of Korean Patent Application Nos. 10-2022-0023675, filed on Feb. 23, 2022, in the Korean Intellectual Property Office, and 10-2022-0189304 filed on Dec. 29, 2022 in the Korean Intellectual Property Office, the entire disclosure of which are incorporated herein by reference for all purposes.

### BACKGROUND

### 1. Field of the Invention

The present disclosure relates to a reverse coffee extraction device using a pump and, more particularly, to a reverse coffee extraction device using a pump to be able to reversely extract coffee water while water supplied down moves up through the pump and then gradually wells up from the bottom of a brewing container.

### 2. Description of the Related Art

In general, coffee has about 500 kinds of components and there are various kinds of coffee. The components of coffee are a little different depending on the producing areas and environments of the coffee. The flavor of coffee is a very various and complex expression and is very important in terms of the value of coffee. A flavor evaluation is based on aroma and taste and has a sensory system of the sense of small, the sense of taste, and the sense of touch. The lipid of coffee that determines the flavor of coffee is a component that does not become gas and is not easily dissolved in water. The lipid of coffee remains in a mouth and generates the sense of touch and has an oily or viscous feeling, which is referred as a body of coffee. The body represents a relative mouth feel that is generated in a mouth in comparison to water.

The texture of coffee, that is, the body means the feeling produced in a mouth after chewing or swallowing food, and, in most cases, the body and the flavor depend on the concentration of a fat soluble lipid contained in coffee.

The mouthfeel of coffee senses ferme, softness, juiciness, oiliness, etc. and determines duration of flavor in a mouth. The feel remaining in a mouth is sensed by substances remaining after extraction of coffee such as solid deposits that is not dissolved in water, and the substances give the entire texture or feel of coffee drinks and produce Brew Colloids, thereby producing the flavor of coffee.

According to coffee extraction method classification by Specialty Coffee Association of America (SCAA), there are two categories of classification methods in a broad sense.

(i) Steeping type: Turkish coffee, boiling, French press, Coffee biggin, Percolator, Vacuum brewer. A type of extracting coffee components by putting crushed coffee into a brewing container and pouring hot water to submerge the powder or pouring cold water and then heating.

(ii) Filtration type: Coffee maker, Drip coffee, Dutch coffee, Coffee urn, Moka pot, Espresso. A type of extracting coffee components through a filter paper or a metallic filter.

The coffee steeped in cold water is called cold Brew Coffee in the West and Dutch coffee in Japan. This coffee is produced through extracting in cold water for 24 to 48 hours and ripening for about 10 days. Although it has good taste, the lipid/fat of the coffee is almost not extracted due to cold water extraction, so the flavor is weak. Further, since the coffee is extracted for a long time at room temperature, there is a greatest defect of causing propagation of various bacteria.

In order to solve the problem, a “Cold brew coffee extractor” has been proposed in Korean Patent No. 10-2015036. There is an advantage that it is possible to obtain cold brew coffee using the extractor, but there is a general problem of coffee not being effectively extracted because the extractor simply uses the height of water.

### SUMMARY

The present disclosure has been made in an effort to solve the problems described above, and an aspect of the present disclosure is to provide a reverse coffee extraction device using a pump to be able to reversely extract coffee water while water supplied down moves up through the pump and then gradually wells up from the bottom of a brewing container.

Another aspect of the present disclosure is to provide a reverse coffee extraction device using a pump in which bubbles can be removed while an air layer moves up in the process that water wells up between coffee particles in a brewing container.

Another aspect of the present disclosure is to provide a reverse coffee extraction device using a pump, the reverse coffee extraction device being able to sanitarily extract coffee by performing extraction with a brewing container half sealed between a delivery pipe and a nozzle.

Another aspect of the present disclosure is to provide a reverse coffee extraction device using a pump, the reverse coffee extraction device extracting strong coffee through a reverse coffee extraction type to give flavor and being able to extract coffee in large quantities by reducing extraction time.

Another aspect of the present disclosure is to provide a reverse coffee extraction device using a pump, the reverse coffee extraction device being able to separate and remove ferrous components contained in water flowing through a supply pipe and to use the purified water with ferrous components removed as coffee water.

In order to achieve the aspects, the present disclosure has the followings as fundamental features in terms of the technological configuration.

Water is supplied down through a reverse extraction unit installed in a coffee maker, and coffee in a brewing container is brewed and extracted to the outside while the water supplied down moves up.

The reverse extraction unit includes: a pump disposed on the bottom in the coffee maker; a 3-way valve connected to the pump; a supply pipe connected to the 3-way valve to supply water; a delivery pipe vertically connected to the top of the 3-way valve and guiding water upward and supplying to the bottom of the brewing container when the pump pumps water supplied through the supply pipe; and a nozzle connected to the top of the brewing container and delivering extracted coffee water upward and extracting outside.

The brewing container is installed between the nozzle and the delivery pipe, and when coffee is brewed into the water supplied upward through the delivery pipe, the coffee water is delivered and extracted through the nozzle.

The reverse coffee extraction device further includes: a passage selecting the supply pipe and formed in the selected supply pipe; a strainer disposed on the outer surface of the supply pipe and having a coupling groove connected to the passage; and an iron separator coupled to the strainer and separating ferrous components contained in water flowing through the supply pipe.

A magnet is disposed in the iron separator so that ferrous components contained in water are separated by magnetism of the magnet, and the iron separator can be coupled to and separated from the strainer.

### BRIEF DESCRIPTION OF THE DRAWINGS

FIG. 1 is a configuration diagram of a reverse coffee extraction device using a pump according to the present disclosure; and

FIG. 2 is a diagram showing another embodiment of a reverse coffee extraction device using a pump according to the present disclosure.

### DETAILED DESCRIPTION

Exemplary embodiments of the present disclosure will be described below with reference to the accompanying drawings in order for those skilled in the art to be able to easily implement the technical spirit of the present disclosure.

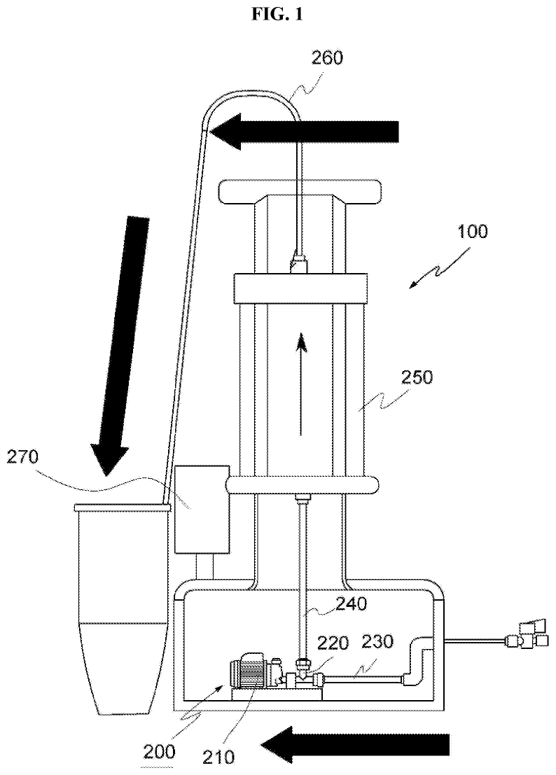

FIG. 1 is a configuration diagram of a reverse coffee extraction device using a pump according to the present disclosure.

The present disclosure includes a fundamental technology of selecting a type in which water is supplied down through a reverse extraction unit 200 installed in a coffee maker and coffee in a brewing container 250 is brewed and extracted to the outside while the water supplied down moves up.

To this end, the reverse extraction unit 200 includes a pump 210 disposed on the bottom in the coffee maker 100, a 3-way valve 220 connected to the pump 210, a supply pipe 230 connected to the 3-way valve 220 to supply water, a delivery pipe 210 vertically connected to the top of the 3-way valve 220 and guiding water upward and supplying to the bottom of the brewing container 250 when the pump 210 pumps water supplied through the supply pipe 230, and a nozzle 260 connected to the top of the brewing container 250 and delivering extracted coffee water upward and extracting outside.

The pump 210 pumps the water upward when water is supplied to the bottom inside the coffee maker 100 through the supply pipe 230, and on/off of the pump 210, the speed of water, time, etc. are controlled and managed by a pump controller 270.

The 3-way valve 220 organically connects the pump 210, the supply pipe 230, and the delivery pipe 240, where the pump 210 is connected to a side of the 3-way valve 220 to be used, the supply pipe 230 is connected opposite the pump 210, and the delivery pipe 240 is vertically connected to be used. Accordingly, when water is supplied to the bottom inside the coffee maker 100 through the supply pipe 230, the water is delivered upward through the delivery pipe 240 by the pumping force of the pump 210. The water delivered upward through the delivery pipe 240 flows through the bottom of the brewing container 250 and gradually wells up.

The brewing container 250 is installed between the nozzle 260 and the delivery pipe 240, and when coffee is brewed into the water supplied upward through the delivery pipe 240, the coffee water is delivered and extracted through the nozzle 260.

Meanwhile, the water flowing to the bottom and gradually welling up in the brewing container 250 passes between particles of coffee and moves up air layers between the coffee particles, thereby removing bubbles. Further, the coffee water with bubbles removed is extracted outside through the nozzle 260.

That is, according to the present disclosure, since water supplied through the supply pipe 230 passes between coffee particles while welling up from the bottom through the pump 210 and the delivery pipe 240, saturated flow is generated. The rising direction of bubbles existing between coffee particles and the flow direction of water rising up are the same, so interference with the flow of water by bubbles decreases, whereby the extraction amount of coffee per unit time increases and strong coffee can be extracted.

Extraction is performed with the brewing container 250 in a half sealing state to the outside due to the characteristic of requiring a sealed chamber when the supply pipe 230 and the delivery pipe 240 are connected, so coffee can be extracted in a safe state.

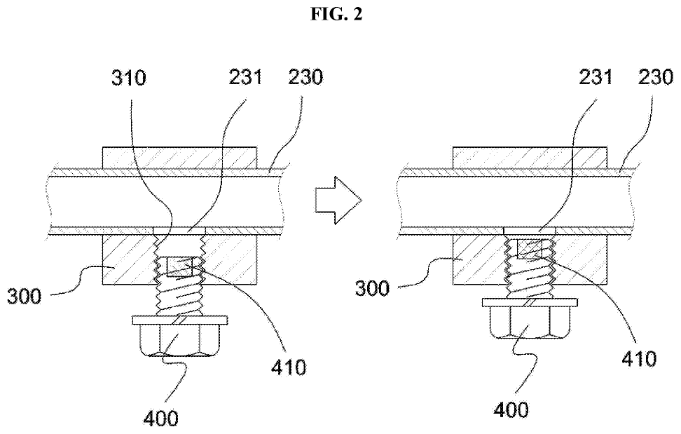

FIG. 2 is a diagram showing another embodiment of a reverse coffee extraction device using a pump according to the present disclosure.

The present disclosure, as shown in FIG. 2, further includes a passage 231 selecting the supply pipe 230 and formed in the selected supply pipe 230, a strainer 300 disposed on the outer surface of the supply pipe 230 and having a coupling groove 310 connected to the passage 231, and an iron separator 400 coupled to the strainer 300 and separating ferrous components contained in water flowing through the supply pipe 230.

A magnet 410 is disposed in the iron separator 400 so that ferrous components contained in the water flowing through the supply pipe 230 is separated by magnetism of the magnet 410.

When the strainer 300 is connected to the supply pipe 230, the passage 231 and the coupling groove 310 are vertically coupled to communicate with each other. In this state, when the iron separator 400 is thread-fastened to the coupling groove 310, the magnet 410 of the iron separator 400 is positioned at the passage 231.

In this state, when water flows into the supply pipe 230, ferrous components contained in the water are separated and removed by magnetism of the magnet 410. Further, after the device is used for a long period of time, it is possible to separate the iron separator 400 from the strainer 300, remove ferrous components stuck to the magnet 410, and couple them back for use.

As described above, those skilled in the art may understand that the present disclosure can be achieved in other detailed ways without changing the spirit or the necessary features of the present disclosure. Therefore, the embodiments described above are only examples and should not be construed as being limitative in all respects. The scope of the present disclosure is defined by the following claims rather than the above detailed description, and all of changes and modifications obtained from the meaning and range of claims and equivalent concepts should be construed as being included in the scope of the present disclosure. According to the present disclosure described above, since water supplied down is moved up through the pump and gradually wells up from the bottom of the brewing container, it is possible to reversely extract coffee water.

Further, according to the present disclosure, since air layers are moved up while water wells up between coffee particles in the brewing container, bubbles are removed.

Further, since extraction is performed with the brewing container half sealed between the delivery pipe and the nozzle, it is possible to extract coffee always in a sanitary state.

Further, according to the present disclosure, since the manner of reversely extracting coffee is employed, it is possible to extract stronger coffee in comparison to the coffee extraction type that uses a difference of water head in the related art. Accordingly, it is possible to have better flavor and extract coffee in large quantities because the extraction time decreases.

Further, since ferrous components contained in the water flowing through the supply pipe are separated and removed by the iron separator before water is supplied to the brewing container, only purified water with ferrous components removed can be used as coffee water.

While the present invention has been described with respect to the specific embodiments, it will be apparent to those skilled in the art that various changes and modifications may be made without departing from the spirit and scope of the invention as defined in the following claims.

What is claimed is:

1. A reverse coffee extraction device comprising:
a pump configured to pump water upwards; and
a brewing container installed above the pump to extract coffee, wherein the water pumped upwards is delivered to the brewing container and moves upwards, and the coffee in the brewing container is brewed and extracted to an outside while the water supplied down moves up.

2. The reverse coffee extraction device of claim 1,
wherein the reverse extraction unit includes:
the pump configured to be disposed on the bottom in the coffee maker;
a 3-way valve connected to the pump;
a supply pipe connected to the 3-way valve to supply water;
a delivery pipe vertically connected to the top of the 3-way valve and guiding water upward and supplying to the bottom of the brewing container when the pump pumps water supplied through the supply pipe; and
a nozzle connected to the top of the brewing container and delivering extracted coffee water upward and extracting outside.

3. The reverse coffee extraction device of claim 2, wherein the brewing container is installed between the nozzle and the delivery pipe, and when coffee is brewed into the water supplied upward through the delivery pipe, the coffee water is delivered and extracted through the nozzle.

4. The reverse coffee extraction device of claim 2, further comprising:
a passage selecting the supply pipe and formed in the selected supply pipe;
a strainer disposed on the outer surface of the supply pipe and having a coupling groove connected to the passage; and
an iron separator coupled to the strainer and separating ferrous components contained in water flowing through the supply pipe.

5. The reverse coffee extraction device of claim 4, wherein a magnet is disposed in the iron separator so that ferrous components contained in water are separated by magnetism of the magnet.

6. The reverse coffee extraction device of claim 4, wherein the iron separator can be coupled to and separated from the strainer.
